(19) United States
(12) Patent Application Publication
(10) Pub. No.: US 2025/0339994 A1
(43) Pub. Date: Nov. 6, 2025

(54) COMPOSITE TRANSFER SYSTEM WITH PLURALITY OF COMPOSITE POSITIONING FLIPPERS

(71) Applicant: The Boeing Company, Arlington, VA (US)

(72) Inventors: Colin Aiden Paul Noronha, Burien, WA (US); Goutam Manjunath Madival, Bangalore (IN); Shuonan Dong, Seattle, WA (US); Silas Lawton Studley, Lake Forest Park, WA (US); Lance Oliver McCann, Seattle, WA (US)

(21) Appl. No.: 18/652,358

(22) Filed: May 1, 2024

(51) Int. Cl. B29C 31/08; B29C 31/00; B29C 70/54; B65G 47/91

(52) U.S. Cl. CPC B29C 31/085; B29C 31/008; B29C 70/54; B65G 47/915

(57) ABSTRACT

A composite transfer cell and associated components and methods are presented. The composite transfer cell comprises a delivery system on a first side of the composite transfer cell; a tool on a second side of the composite transfer cell; and a composite transfer system between the first side and the second side of the composite transfer cell, the composite transfer system comprising a plurality of flipper arms independently movable in a vertical direction and rotatingly movable to lift and place a composite charge from the delivery system to the tool.

### BACKGROUND INFORMATION

### 1. Field

The present disclosure relates generally to composite positioning and more specifically to positioning a composite charge onto a tool.

### 2. Background

Longitudinal composite structures, such as aircraft stringers, can present manufacturing challenges. Currently composite stringers are laid up by hand and cranes are used for material handling. Hand lay-up and crane handling are undesirably slow and costly.

Therefore, it would be desirable to have a method and apparatus that takes into account at least some of the issues discussed above, as well as other possible issues. For example, it would be desirable to provide a composite handling system that would be at least one of more flexible, faster, or less costly than a crane system. As another example, it would be desirable to provide a composite handling system within an automated composite positioning system.

### SUMMARY

An embodiment of the present disclosure provides a composite transfer cell. The composite transfer cell comprises a delivery system on a first side of the composite transfer cell, a tool on a second side of the composite transfer cell, and a composite transfer system between the first side and the second side of the composite transfer cell. The composite transfer system comprises a plurality of flipper arms independently movable in a vertical direction and rotatingly movable to lift and place a composite charge from the delivery system to the tool.

Another embodiment of the present disclosure provides a composite transfer system. The composite transfer system comprises a plurality of vertical towers and a plurality of flipper arms connected to the plurality of vertical towers by a plurality of vertical motors and a plurality of rotary motors.

Yet another embodiment of the present disclosure provides a pneumatic and mechanical connector comprising a first joint configured to allow movement in a first axis, a second joint configured to allow movement in a second axis, and a centering component.

A yet further embodiment of the present disclosure provides a composite charge transportation pallet. The composite charge transportation pallet comprises a layup pallet portion; and a nesting preform transfer portion removable from the layup pallet portion.

A further embodiment of the present disclosure provides a method of positioning a composite charge. A composite charge on a nesting preform transfer portion of a composite charge transportation pallet is lifted. The composite charge and the nesting preform transfer portion are rotated. The composite charge is lowered towards a tool to place the composite charge in contact with a tool.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIGS. 2A and 2B are an illustration of a block diagram of a manufacturing environment in accordance with an illustrative embodiment;

FIG. 3 is an illustration of an isometric view of a portion of a composite transfer cell in a manufacturing environment in accordance with an illustrative embodiment;

FIG. 4 is an illustration of an isometric view of composite transfer cell with a composite charge transportation pallet within a manufacturing environment in accordance with an illustrative embodiment;

FIG. 5 is an illustration of an isometric view of a composite transfer system lifting a portion of a composite charge transportation pallet in a manufacturing environment in accordance with an illustrative embodiment;

FIG. 6 is an illustration of an isometric view of a composite transfer system positioning a portion of a composite charge transportation pallet over a tool in a manufacturing environment in accordance with an illustrative embodiment;

FIG. 7 is an illustration of an isometric view of a composite transfer system positioning a portion of a composite charge transportation pallet over a tool in a manufacturing environment in accordance with an illustrative embodiment;

FIG. 8 is an illustration of an isometric view of a composite transfer system placing a composite charge on a composite charge transportation pallet in contact with a tool in a manufacturing environment in accordance with an illustrative embodiment;

FIG. 9 is an illustration of an isometric view of a composite transfer system positioning after placing a composite charge onto a tool in a manufacturing environment in accordance with an illustrative embodiment;

FIG. 10 is an illustration of an isometric view of a composite transfer system placing a curvature into a composite charge on a composite charge transportation pallet in a manufacturing environment in a manufacturing environment in accordance with an illustrative embodiment;

FIG. 11 is an illustration of an isometric view of a pneumatic and mechanical connector for a composite transfer system in accordance with an illustrative embodiment;

FIG. 12 is an illustration of a bottom view of a pneumatic and mechanical connector for a composite transfer system in accordance with an illustrative embodiment;

FIG. 13 is an illustration of a phantom side view of a pneumatic and mechanical connector for a composite transfer system in accordance with an illustrative embodiment;

FIG. 14 is an illustration of an exploded view of a pneumatic and mechanical connector for a composite transfer system in accordance with an illustrative embodiment;

FIG. 15 is an illustration of an isometric view of a pneumatic and mechanical connector in accordance with an illustrative embodiment;

FIG. 16 is an illustration of a front view of a composite transfer system placing a curvature into a composite charge transportation pallet in a manufacturing environment in accordance with an illustrative embodiment;

FIG. 17 is an illustration of an exploded view of a composite charge transportation pallet in a manufacturing environment in accordance with an illustrative embodiment;

FIGS. 18A and 18B are a flowchart of a method of positioning a composite charge in accordance with an illustrative embodiment;

FIG. 19 is an illustration of an aircraft manufacturing and service method in a form of a block diagram in accordance with an illustrative embodiment; and

FIG. 20 is an illustration of an aircraft in a form of a block diagram in which an illustrative embodiment may be implemented.

### DETAILED DESCRIPTION

The illustrative examples present a composite transfer cell comprising a composite transfer system that can pick up a flat composite charge from a delivery system such as a conveyor, flip it over about a longitudinal axis, and position it onto a tool. By flipping the composite charge one hundred and eighty degrees, a face of the composite charge that is exposed while on the delivery system is placed into contact with the tool. In some illustrative examples, the composite transfer system can place the composite charge into a lengthwise contour prior to positioning the composite charge onto the tool. The composite transfer cell contains a two-part composite charge transportation pallet that interfaces with multiple flipper arms of the composite transfer system. The plurality of flipper arms can be independently controlled to introduce a contour into the composite charge.

The layup pallet portion of the composite charge transportation pallet acts as a base and sits flat on a conveyor. A nesting preform transfer portion of the composite charge transportation pallet is a top of the composite charge transportation pallet. The nesting preform transfer portion is flexible and can be connected to the plurality of flipper arms by pneumatic and mechanical connectors.

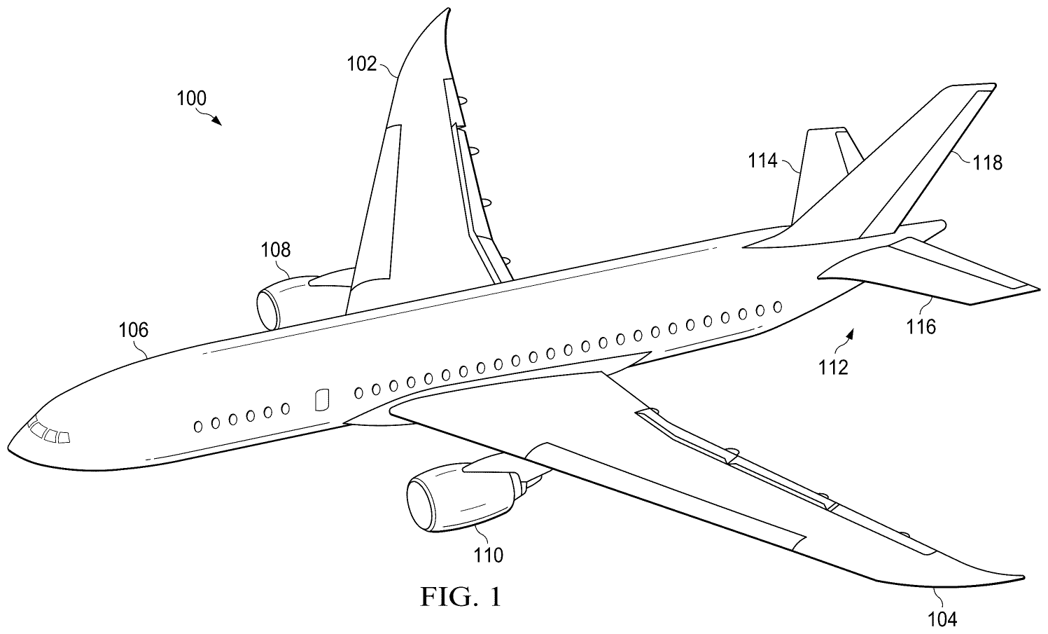

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Composite components of aircraft 100 can be manufactured using the composite transfer cell of the illustrative examples. Aircraft 100 is an example of an aircraft that can have components manufactured using the method of the illustrative examples. A composite component of at least one of wing 102, wing 104, or body 106 can be manufactured using at least one of a composite transfer cell and methods of the illustrative examples.

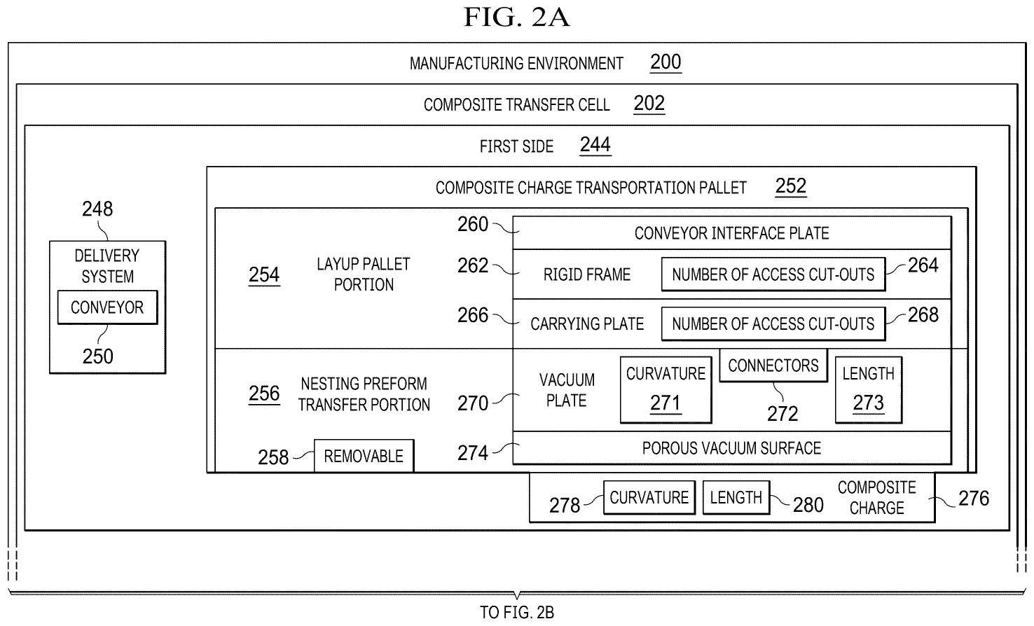

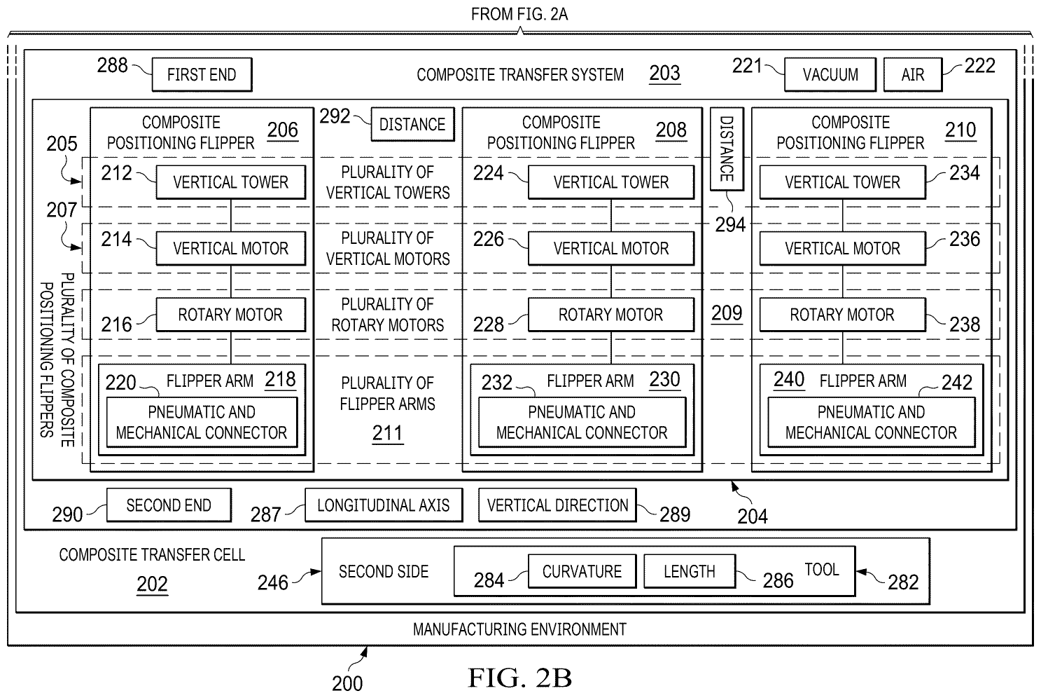

Turning now to FIGS. 2A and 2B, an illustration of a block diagram of a manufacturing environment is depicted in accordance with an illustrative embodiment. Manufacturing environment 200 comprises composite transfer cell 202 configured to pick up composite charge 276, flip composite charge 276 over longitudinal axis 287, and position composite charge 276 onto tool 282. In some illustrative examples, composite charge 276 can be referred to as a composite layup or a composite preform. Composite charge 276 is formed of multiple layers of fiber-reinforced polymeric matrix. Composite transfer cell 202 can be used in manufacturing any desirable composite part of aircraft 100 of FIG. 1.

Composite transfer cell 202 comprises a composite transfer system 203 configured to pick up composite charge 276 from delivery system 248 such as conveyor 250, flip composite charge 276 over about longitudinal axis 287, and position composite charge 276 onto tool 282. By flipping composite charge 276 one hundred and eighty degrees, a face of the composite charge 276 that is exposed while on delivery system 248 is placed into contact with tool 282. In some illustrative examples, composite transfer system 203 can place composite charge 276 into a lengthwise contour prior to positioning composite charge 276 onto tool 282. Composite transfer cell 202 contains composite charge transportation pallet 252 that interfaces with multiple flipper arms of composite transfer system 203. Plurality of flipper arms 211 can be independently controlled to introduce a contour, curvature 278, into composite charge 276.

Composite charge 276 can have any desirable shape or size. In some illustrative examples, composite charge 276 is planar prior to being lifted and transported by plurality of flipper arms 211. In some illustrative examples, plurality of flipper arms 211 form composite charge 276 to match tool 282 prior to positioning composite charge 276 onto tool 282. In some illustrative examples, plurality of flipper arms 211 form curvature 278 into composite charge 276 so that composite charge 276 matches curvature 284 of tool 282.

Composite transfer cell 202 comprises delivery system 248 on first side 244 of composite transfer cell 202, tool 282 on second side 246 of composite transfer cell 202, and composite transfer system 203 between first side 244 and second side 246 of composite transfer cell 202. Composite transfer system 203 comprises plurality of flipper arms 211 independently movable in vertical direction 289 and rotatingly movable to lift and place composite charge 276 from delivery system 248 to tool 282. In some illustrative examples, plurality of flipper arms 211 is also independently movable in rotation about longitudinal axis 287.

Composite transfer system 203 further comprises plurality of vertical towers 205, wherein plurality of flipper arms 211 are connected to plurality of vertical towers 205 by plurality of vertical motors 207 and plurality of rotary motors 209. In this illustrative example, plurality of flipper arms 211 are portions of plurality of composite positioning flippers 204. Each composite positioning flipper of plurality of composite positioning flippers 204 comprises a respective flipper arm and accompanying systems for movement and control of the respective flipper arm.

Plurality of vertical motors 207 can move respective flipper arms of plurality of flipper arms 211 in vertical direction 289 along respective vertical towers of plurality of vertical towers 205. Each vertical motor of plurality of vertical motors 207 can move a respective flipper arm in vertical direction 289 using a track, a rail, wheels, a pulley system, or any other desirable type of movement assembly.

Plurality of rotary motors 209 can rotate respective flipper arms of plurality of flipper arms 211 relative to respective vertical towers of plurality of vertical towers 205. Each rotary motor of plurality of rotary motors 209 can rotate a respective flipper arm using a hinge, pivot point, pivot joint, or any other desirable movable connection. In some illustrative examples, movement of plurality of flipper arms 211 in vertical direction 289 moves plurality of rotary motors 209 and associated hinge, pivot point, pivot joint, or other desirable movable connection in vertical direction 289.

As depicted, plurality of composite positioning flippers 204 comprises three composite positioning flippers: composite positioning flipper 206, composite positioning flipper 208, and composite positioning flipper 210. In other non-depicted illustrative examples, plurality of composite positioning flippers 204 comprises more than three composite positioning flippers. In other non-depicted illustrative examples, plurality of composite positioning flippers 204 comprises any desirable quantity of flippers based on at least one of length 280 or material of composite charge 276. In some illustrative examples, composite transfer system 203 is modular and composite positioning flippers can be added or removed from plurality of composite positioning flippers 204 based on at least one of length 280 or material of composite charge 276. Composite positioning flipper 206 comprises vertical tower 212, vertical motor 214, rotary motor 216, and flipper arm 218. Flipper arm 218 has pneumatic and mechanical connector 220 configured to connect flipper arm 218 to composite charge transportation pallet 252. Vertical motor 214 is configured to move flipper arm 218 in vertical direction 289 along vertical tower 212. In some illustrative examples, vertical motor 214 can move flipper arm 218 in vertical direction 289 using a track, a rail, wheels, a pulley system, or any other desirable type of movement assembly. Rotary motor 216 is configured to rotate flipper arm 218 from first side 244 to second side 246. Rotary motor 216 is configured to rotate flipper arm 218 about longitudinal axis 287 of composite transfer system 203. Rotary motor 216 can rotate flipper arm 218 using a hinge, pivot point, pivot joint, or any other desirable movable connection.

Composite positioning flipper 208 comprises vertical tower 224, vertical motor 226, rotary motor 228, and flipper arm 230. Flipper arm 230 has pneumatic and mechanical connector 232 configured to connect flipper arm 230 to composite charge transportation pallet 252. Vertical motor 226 is configured to move flipper arm 230 in vertical direction 289 along vertical tower 224. In some illustrative examples, vertical motor 226 can move flipper arm 230 in vertical direction 289 using a track, a rail, wheels, a pulley system, or any other desirable type of movement assembly. Rotary motor 228 is configured to rotate flipper arm 230 from first side 244 to second side 246. Rotary motor 228 is configured to rotate flipper arm 230 about longitudinal axis 287 of composite transfer system 203. Rotary motor 228 can rotate flipper arm 230 using a hinge, pivot point, pivot joint, or any other desirable movable connection.

Composite positioning flipper 210 comprises vertical tower 234, vertical motor 236, rotary motor 238, and flipper arm 240. Flipper arm 240 has pneumatic and mechanical connector 242 configured to connect flipper arm 240 to composite charge transportation pallet 252. Vertical motor 236 is configured to move flipper arm 240 in vertical direction 289 along vertical tower 234. In some illustrative examples, vertical motor 236 can move flipper arm 240 in vertical direction 289 using a track, a rail, wheels, a pulley system, or any other desirable type of movement assembly. Rotary motor 238 is configured to rotate flipper arm 240 from first side 244 to second side 246. Rotary motor 238 is configured to rotate flipper arm 240 about longitudinal axis 287 of composite transfer system 203. Rotary motor 238 can rotate flipper arm 240 using a hinge, pivot point, pivot joint, or any other desirable movable connection.

Plurality of vertical motors 207 enables lifting composite charge 276 on nesting preform transfer portion 256 by plurality of flipper arms 211. Plurality of vertical motors 207 enables lowering of composite charge 276 onto tool 282 by plurality of flipper arms 211. Plurality of vertical motors 207 is configured for independent movement of plurality of flipper arms 211. By moving plurality of flipper arms 211 independently in vertical direction 289, curvature 278 can be placed into length 280 of composite charge 276.

In some illustrative examples, each flipper arm of plurality of flipper arms 211 comprises a secondary vertical motor configured to move a portion of a respective flipper arm. In some illustrative examples, a secondary vertical motor enables placing curvature 278 into length 280 of composite charge 276 prior to rotating composite charge 276. Each flipper arm of plurality of flipper arms 211 comprises a pneumatic and mechanical connector configured to accommodate different vertical positions of plurality of flipper arms 211 to impart curvature 278 in composite charge 276.

Each flipper arm of plurality of flipper arms 211 comprises a respective pneumatic and mechanical connector. In this illustrative example, flipper arm 218 comprises pneumatic and mechanical connector 220, flipper arm 230 comprises pneumatic and mechanical connector 232, and flipper arm 240 comprises pneumatic and mechanical connector 242.

Each pneumatic and mechanical connector is configured to mechanically connect plurality of flipper arms 211 to composite charge transportation pallet 252. Composite charge transportation pallet 252 is a two-part pallet. Composite charge transportation pallet 252 has layup pallet portion 254 and nesting preform transfer portion 256 removable 258 from layup pallet portion 254.

In some illustrative examples, layup pallet portion 254 comprises conveyor interface plate 260 to connect and retain layup pallet portion 254 on delivery system 248. Conveyor interface plate 260 is connected to rigid frame 262. Rigid frame 262 is configured to receive pressure from laying up composite charge 276 on composite charge transportation pallet 252.

In some illustrative examples, layup pallet portion 254 has number of access cut-outs configured to allow access to connectors 272 of nesting preform transfer portion 256. In this illustrative example, layup pallet portion 254 further comprises rigid frame 262 and carrying plate 266. Carrying plate 266 is configured to interface with nesting preform transfer portion 256. Carrying plate 266 comprises number of access cut-outs 268 for allowing pneumatic access to vacuum plate 270.

Rigid frame 262 and carrying plate 266 have overlapping access cut-outs to allow access to connectors 272 of vacuum plate 270. In this illustrative example, rigid frame 262 comprises number of access cut-outs 264 and carrying plate 266 comprises number of access cut-outs 268. Number of access cut-outs 264 and number of access cut-outs 264 overlap each other. A quantity of access cut-outs for layup pallet portion 254 is designed based on a quantity of connectors 272.

Nesting preform transfer portion 256 comprises vacuum plate 270 and porous vacuum surface 274. Composite charge 276 is placed in contact with porous vacuum surface 274 of nesting preform transfer portion 256. Vacuum plate 270 distributes at least one of vacuum or air to porous vacuum surface 274. Vacuum plate 270 is formed of a material sufficiently flexible to allow for a curvature 271 to be imparted along length 273 of vacuum plate 270. Vacuum plate 270 is formed of a material sufficiently flexible to allow for curvature 278 to be imparted along length 280 of composite charge 276.

Each respective pneumatic and mechanical connector is configured to accommodate movements due to different vertical positions of plurality of flipper arms 211 to impart curvature 278 in composite charge 276. Each pneumatic and mechanical connector on plurality of flipper arms 211 comprises a plurality of joints to allow for movement. In some illustrative examples, each pneumatic and mechanical connector comprises a first joint configured to allow movement in a first axis; a second joint configured to allow movement in a second axis; and a centering component.

In some illustrative examples, the first joint comprises a slider joint. In some illustrative examples, the centering component comprises a number of springs. In some illustrative examples, the second joint comprises a rocker joint. In some illustrative examples, the second joint comprises a ball and socket joint such that the second joint is configured to allow movement in the second axis and a third axis.

Plurality of flipper arms 211 is rotatingly movable about a longitudinal axis 287 of composite transfer system 203. Longitudinal axis 287 of composite transfer system 203 is parallel to length 286 of tool 282. In some illustrative examples, longitudinal axis 287 of composite transfer system 203 is also parallel to a longitudinal axis of composite charge 276.

Plurality of composite positioning flippers 204 are aligned along longitudinal axis 287 of composite transfer system 203. Composite positioning flipper 206 is separated from composite positioning flipper 208 along longitudinal axis 287 by distance 292. Composite positioning flipper 208 is separated from composite positioning flipper 210 along longitudinal axis 287 by distance 294. In some illustrative examples, distance 292 and distance 294 are the same. In some illustrative examples, distance 292 and distance 294 are different. In some illustrative examples, distance 292 and distance 294 are adjustable.

Distance 292 and distance 294 can be set based on curvature 278 of composite charge 276. A quantity of composite positioning flippers in plurality of composite positioning flippers 204 can be set based on curvature 278 of composite charge 276.

Composite charge 276 is either laid up or placed onto composite charge transportation pallet 252. Composite charge transportation pallet 252 is delivered to composite transfer cell 202 by delivery system 248.

Composite charge 276 on nesting preform transfer portion 256 of composite charge transportation pallet 252 is lifted. Composite transfer system 203 within composite transfer cell 202 lifts composite charge 276 on nesting preform transfer portion 256 using plurality of flipper arms 211. In some illustrative examples, lifting composite charge 276 on nesting preform transfer portion 256 comprises lifting nesting preform transfer portion 256 using plurality of flipper arms 211 and plurality of vertical motors 207.

Composite charge 276 and nesting preform transfer portion 256 are rotated. Plurality of flipper arms 211 rotate composite charge 276 on nesting preform transfer portion 256 about longitudinal axis 287 of composite transfer system 203. In some illustrative examples, rotating composite charge 276 and nesting preform transfer portion 256 comprises rotating plurality of flipper arms 211 using plurality of rotary motors 209.

By rotating composite charge 276 on nesting preform transfer portion 256 about longitudinal axis 287, plurality of flipper arms 211 move composite charge 276 on nesting preform transfer portion 256 from first side 244 of composite transfer cell 202 to second side 246 of composite transfer cell 202. By rotating composite charge 276 on nesting preform transfer portion 256 about longitudinal axis 287, plurality of flipper arms 211 flip composite charge 276 one hundred and eighty degrees. By flipping composite charge 276 one hundred and eighty degrees, a face of the composite charge 276 that is exposed while on delivery system 248 will be placed into contact with tool 282. By rotating composite charge 276 on nesting preform transfer portion 256 about longitudinal axis 287, plurality of flipper arms 211 move up and over plurality of vertical towers 205 so that plurality of flipper arms 211 move from first side 244 to second side 246.

Composite charge 276 is lowered towards tool 282 to place composite charge 276 in contact with tool 282. Composite charge 276 is lowered by movement of plurality of flipper arms 211. In some illustrative examples, lowering composite charge 276 towards tool 282 comprises lowering plurality of flipper arms 211 using plurality of vertical motors 207, wherein each of plurality of vertical motors 207 independently moves a respective flipper arm of plurality of flipper arms 211.

Tool 282 is positioned on second side 246 of composite transfer cell 202. In some illustrative examples, tool 282 has curvature 284. In those illustrative examples, curvature 278 is placed into composite charge 276 prior to placing composite charge 276 into contact with tool 282. By placing curvature 278 into composite charge 276, composite charge 276 matches curvature 284 of tool 282.

Composite charge 276 is held against nesting preform transfer portion 256 using vacuum 221 supplied to nesting preform transfer portion 256 as composite charge 276 is lifted and then rotated. Vacuum 221 is released when composite charge 276 is in contact with tool 282. In some illustrative examples, composite charge is pushed against tool 282 with air 222 directed from nesting preform transfer portion 256.

The illustration of manufacturing environment 200 in FIGS. 2A and 2B is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

Although not depicted in FIGS. 2A and 2B, mechanical restraints can be present to grip the composite charge against the tool when the composite charge is in contact with the tool and the nesting preform transfer portion. The mechanical restraints can take the form of clips, clamps, needles, or any other desirable type of restraint.

In some illustrative examples, composite transfer system 203 further comprises a respective secondary vertical motor (not depicted) connected to each flipper arm of plurality of flipper arms 211. In some illustrative examples, each respective secondary vertical motor is configured to move a portion of a respective flipper arm.

In some illustrative examples, actuation on individual arms using secondary vertical motors could allow forming of curvature 278 into composite charge 276 prior to or during rotation of composite charge 276 about longitudinal axis 287.

To rotate composite charge 276 about longitudinal axis 287, each rotary motor of plurality of rotary motors 209 is aligned. Each flipper arm can align its respective rotation axis using plurality of vertical motors 207. When present, the secondary vertical motor (not depicted) can allow each flipper arm of plurality of flipper arms 211 to have an independent vertical position not dependent on the location of a respective rotary motor. Independent vertical movement of each respective flipper arm allows for nesting preform transfer portion 256 with a contour to be flipped. A secondary vertical motor provides an additional z-actuation point for unique z positioning for each respective flipper arm.

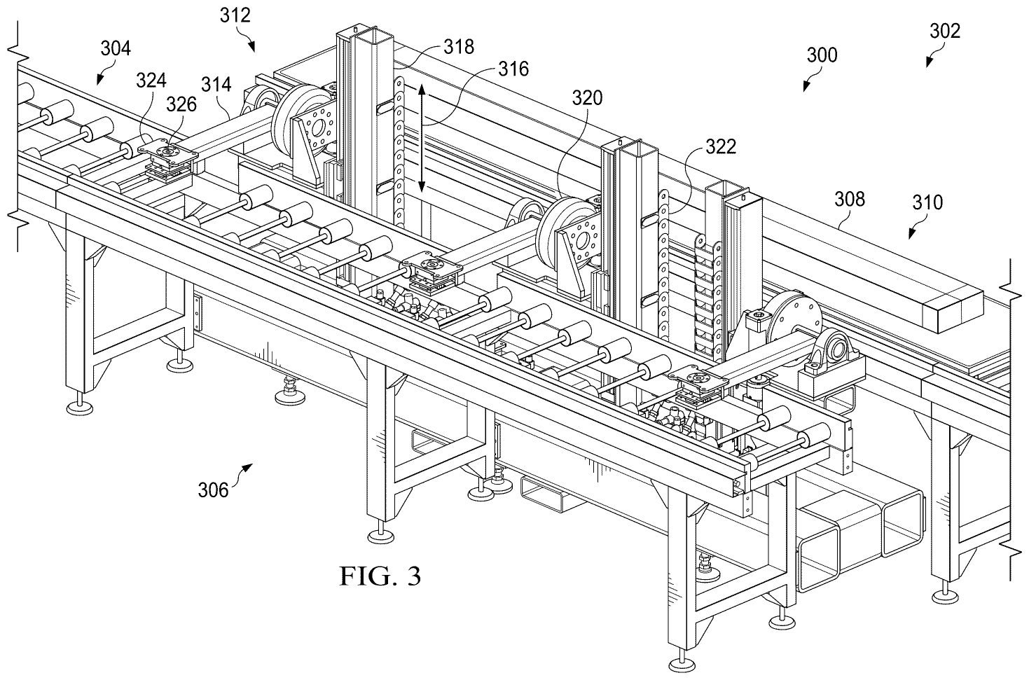

Turning now to FIG. 3, an illustration of an isometric view of a portion of a composite transfer cell in a manufacturing environment is depicted in accordance with an illustrative embodiment. Composite transfer cell 300 is depicted in view 302. In view 302, delivery system 304 is on first side 306 of composite transfer cell 300. Tool 308 is on second side 310 of composite transfer cell 300. Composite transfer system 312 is between first side 306 and second side 310 of composite transfer cell 300. Composite transfer system 312 comprises plurality of flipper arms 314 independently movable in vertical direction 316 and rotatingly movable to lift and place a composite charge from delivery system 304 to tool 308.

Plurality of flipper arms 314 is connected to plurality of vertical towers 318 by plurality of vertical motors 322 and plurality of rotary motors 320. Each of plurality of flipper arms 314 is independently moveable by plurality of vertical motors 322. A curvature can be imparted into a composite charge held by plurality of flipper arms 314 by independently moving plurality of flipper arms 314 using plurality of vertical motors 322.

Plurality of flipper arms 314 can be rotated using plurality of rotary motors 320 to move a composite charge from first side 306 to second side 310 of composite transfer cell 300. Plurality of flipper arms 314 comprise plurality of pneumatic and mechanical connectors 324. Plurality of pneumatic and mechanical connectors 324 comprise plurality of quick connectors 326 to interface with a composite charge transportation pallet. Plurality of quick connectors 326 mechanically connect plurality of flipper arms 314 to a composite charge transportation pallet. Plurality of pneumatic and mechanical connectors 324 can be used to provide at least one of vacuum or air to a composite charge transportation pallet to hold or release a composite charge.

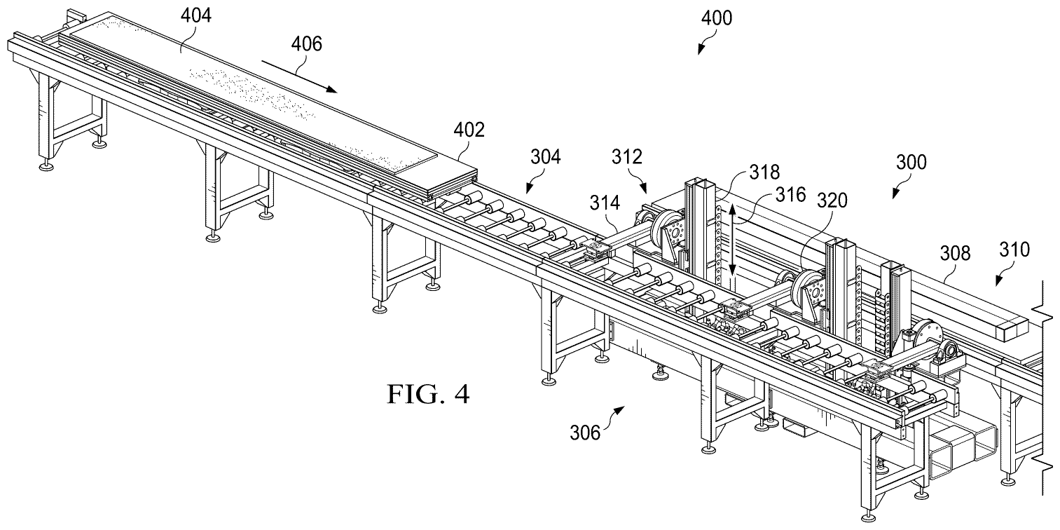

FIGS. 4-9 are illustrations of views of the

composite transfer cell with composite transfer system 312 receiving composite charge transportation pallet 402 on delivery system 304. Composite charge 404 is present on composite charge transportation pallet 402.

Composite charge 404 is lifted on nesting preform transfer portion 502 of composite charge transportation pallet 402. Layup pallet portion 504 of composite charge transportation pallet 402 is left on delivery system 304.

Composite charge 404 and nesting preform transfer portion 502 are rotated by plurality of flipper arms 314. Plurality of flipper arms 314 lower composite charge 404 towards tool 308 to place composite charge 404 in contact with tool 308.

Turning now to FIG. 4, an illustration of an isometric view of composite transfer cell with a composite charge transportation pallet within a manufacturing environment is depicted in accordance with an illustrative embodiment. In view 400, composite charge transportation pallet 402 is shown on delivery system 304. Composite charge 404 is present on composite charge transportation pallet 402. Composite charge 404 can be laid up on or picked and placed onto composite charge transportation pallet 402. Composite charge transportation pallet 402 moves along delivery system 304 in direction 406 towards plurality of flipper arms 314.

When composite charge transportation pallet 402 reaches plurality of flipper arms 314, plurality of flipper arms 314 will grip and lift a portion of composite charge transportation pallet 402. When composite charge transportation pallet 402 arrives at plurality of flipper arms 314, plurality of quick connectors 326 are positioned beneath composite charge transportation pallet 402. When composite charge transportation pallet 402 arrives at plurality of flipper arms 314, plurality of quick connectors 326 mechanically connect plurality of flipper arms 314 to composite charge transportation pallet 402.

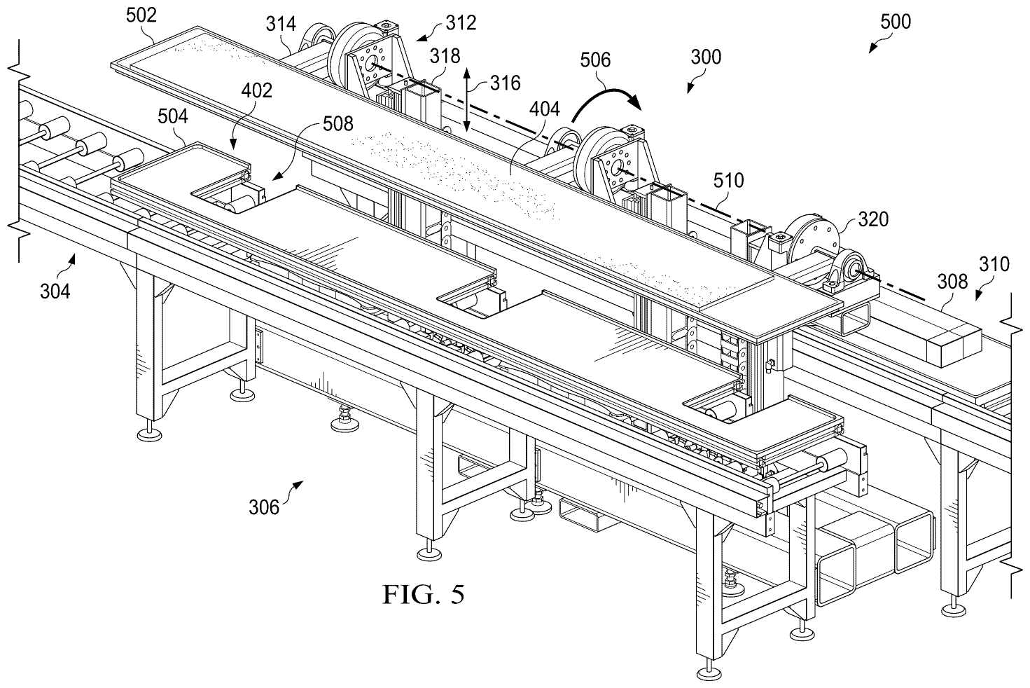

Turning now to FIG. 5, an illustration of an isometric view of a composite transfer system lifting a portion of a composite charge transportation pallet in a manufacturing environment is depicted in accordance with an illustrative embodiment. Between view 400 and view 500, composite charge transportation pallet 402 has arrived at plurality of flipper arms 314. Plurality of quick connectors 326 has mechanically connected plurality of flipper arms 314 to nesting preform transfer portion 502 of composite charge transportation pallet 402.

In view 500, nesting preform transfer portion 502 of composite charge transportation pallet 402 has been lifted from layup pallet portion 504 by plurality of flipper arms 314. In view 500, nesting preform transfer portion 502 of composite charge transportation pallet 402 is about to be rotated in direction 506 using plurality of flipper arms 314. Rotating nesting preform transfer portion 502 in direction 506 rotates nesting preform transfer portion 502 about longitudinal axis 510 of composite transfer system 312. Longitudinal axis 510 of composite transfer system 312 is parallel to a length of tool 308. Longitudinal axis 510 of composite transfer system 312 extends through each rotary motor of rotary motors 320 of composite transfer system 312. As depicted, longitudinal axis 510 of composite transfer system 312 is also parallel to a longitudinal axis of composite charge 404.

Layup pallet portion 504 comprises a rigid frame configured to receive pressure from laying up composite charge 404 on composite charge transportation pallet 402. Although composite charge 404 is depicted as a rectangular charge, composite charge 404 can have any desirable shape or size.

Layup pallet portion 504 further comprises a conveyor interface plate connected to the rigid frame. The conveyor interface plate interfaces with delivery system 304.

The rigid frame has number of access cut-outs 508 configured to allow access to connectors of nesting preform transfer portion 502. Number of access cut-outs 508 allow for plurality of flipper arms 314 to connect to nesting preform transfer portion 502 and lift nesting preform transfer portion 502 away from layup pallet portion 504. Layup pallet portion 504 remains on delivery system 304 while plurality of flipper arms 314 lift and then rotate nesting preform transfer portion 502.

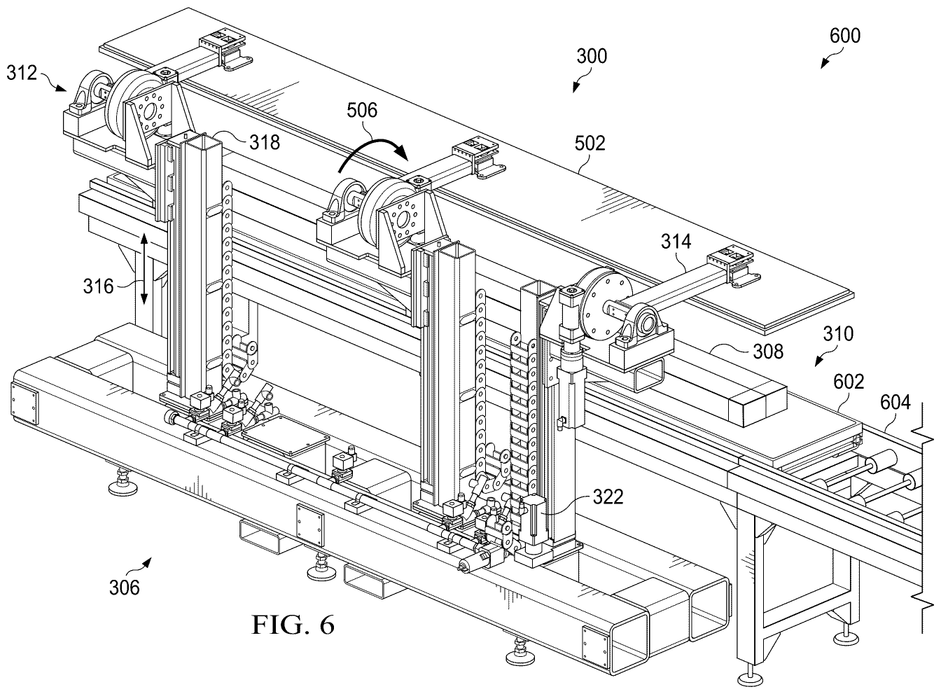

Turning now to FIG. 6, an illustration of an isometric view of a composite transfer system positioning a portion of a composite charge transportation pallet over a tool in a manufacturing environment is depicted in accordance with an illustrative embodiment. View 600 is a view of plurality of flipper arms 314 positioning nesting preform transfer portion 502 of composite charge transportation pallet 402 over tool 308.

Between view 500 and view 600, plurality of flipper arms 314 have rotated in direction 506. By rotating plurality of flipper arms 314 in direction 506, nesting preform transfer portion 502 has been moved from first side 306 to second side 310. By rotating plurality of flipper arms 314 in direction 506, composite charge 404 is now upside down. By rotating plurality of flipper arms 314 in direction 506, plurality of flipper arms 314 flip composite charge 404 one hundred and eighty degrees. By flipping composite charge 404 one hundred and eighty degrees, a face of the composite charge 404 that is exposed while on delivery system 304 will be placed into contact with tool 308. Composite charge 404 is maintained on nesting preform transfer portion 502 by vacuum provided by composite transfer system 312.

As depicted, tool 308 is present on transportation pallet 602. Transportation pallet 602 can move along delivery system 604. In this illustrative example, delivery system 604 takes the form of a conveyor. After composite charge 404 is placed onto tool 308, delivery system 604 can move tool 308 with composite charge 404 on tool 308 to a next manufacturing cell.

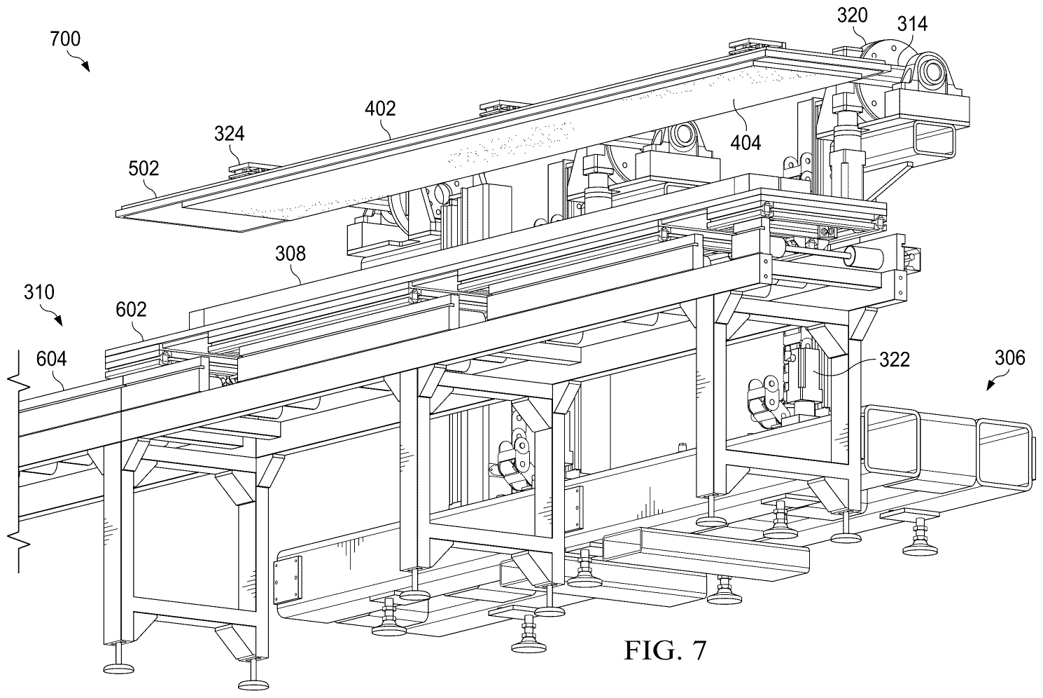

Turning now to FIG. 7, an illustration of an isometric view of a composite transfer system positioning a portion of a composite charge transportation pallet over a tool in a manufacturing environment is depicted in accordance with an illustrative embodiment. View 700 is a view from second side 310. In view 700, composite charge 404 on nesting preform transfer portion 502 is visible. Plurality of flipper arms 314 can be used to maneuver composite charge 404 on nesting preform transfer portion 502 relative to tool 308.

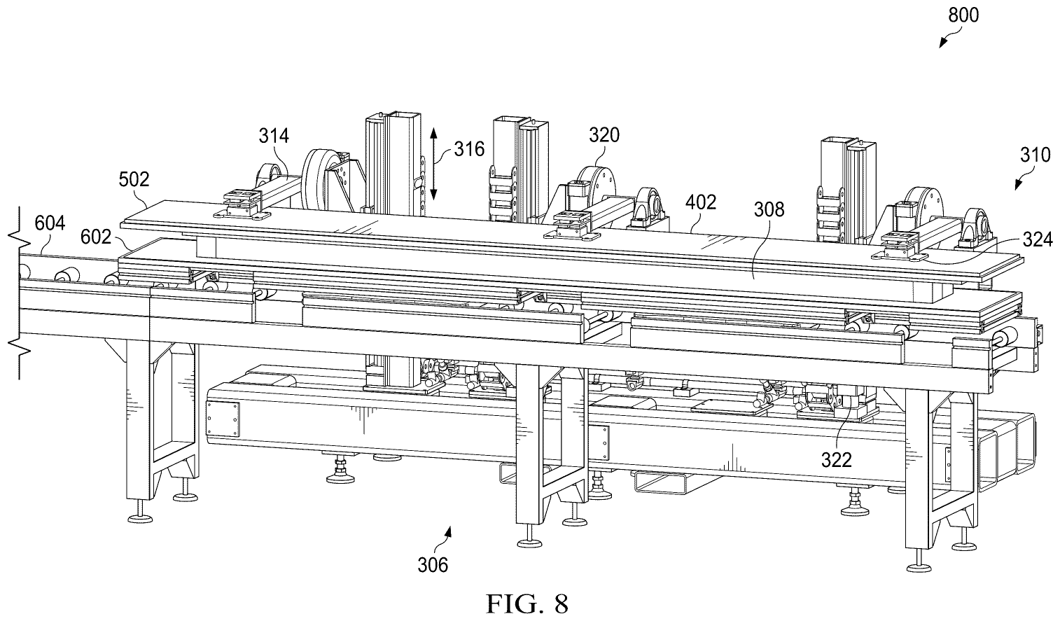

Turning now to FIG. 8, an illustration of an isometric view of a composite transfer system placing a composite charge on a composite charge transportation pallet in contact with a tool in a manufacturing environment is depicted in accordance with an illustrative embodiment. In view 800, plurality of flipper arms 314 have been used to lower composite charge 404 on nesting preform transfer portion 502 into contact with tool 308. In view 800, plurality of flipper arms 314 have moved in vertical direction 316 towards tool 308.

In some illustrative examples, nesting preform transfer portion 502 can be lowered into contact with tooling (not depicted). In some illustrative examples, composite charge 404 is indexed. In some illustrative examples, composite charge 404 is indexed using needle grippers (not depicted) that engage with excess material.

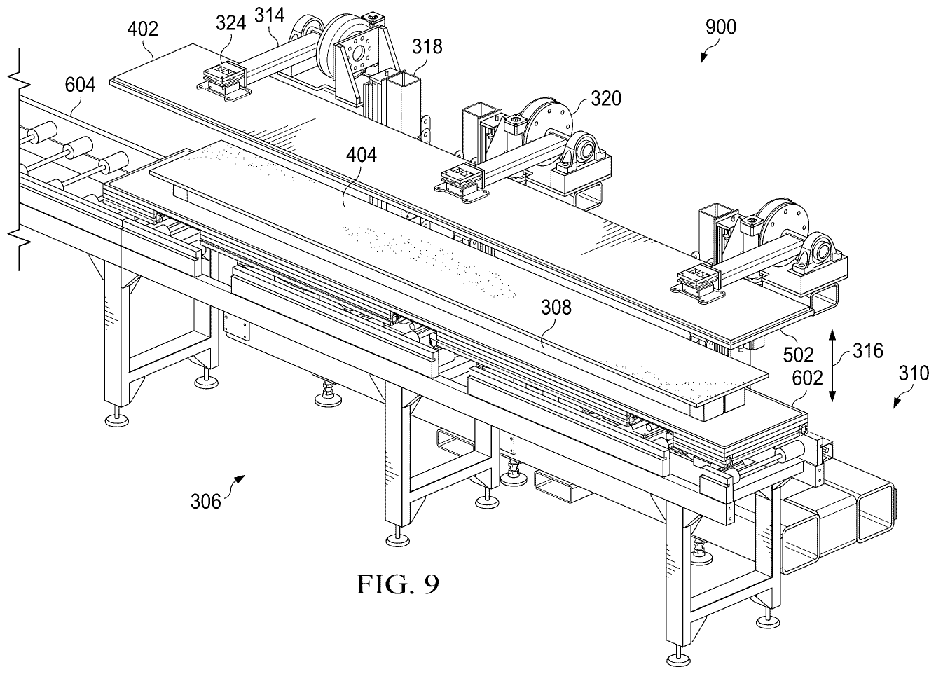

Turning now to FIG. 9, an illustration of an isometric view of a composite transfer system positioning after placing a composite charge onto a tool in a manufacturing environment is depicted in accordance with an illustrative embodiment. In view 900, composite charge 404 is present on tool 308. Plurality of flipper arms 314 has moved in vertical direction 316 away from tool 308. Plurality of flipper arms 314 has moved nesting preform transfer portion 502 in vertical direction 316 up and away from composite charge 404.

In some illustrative examples, between view 800 and view 900 nesting preform transfer portion 502 releases composite charge 404 by stopping the vacuum to composite charge 404. In some illustrative examples, between view 800 and view 900, nesting preform transfer portion 502 releases composite charge 404 by pushing composite charge 404 against tool 308 with air directed from nesting preform transfer portion 502. After placing composite charge 404 on tool 308, plurality of flipper arms 314 can return to a starting position to prepare for another pallet. After placing composite charge 404 on tool 308, plurality of flipper arms 314 can rotate back to first side 306.

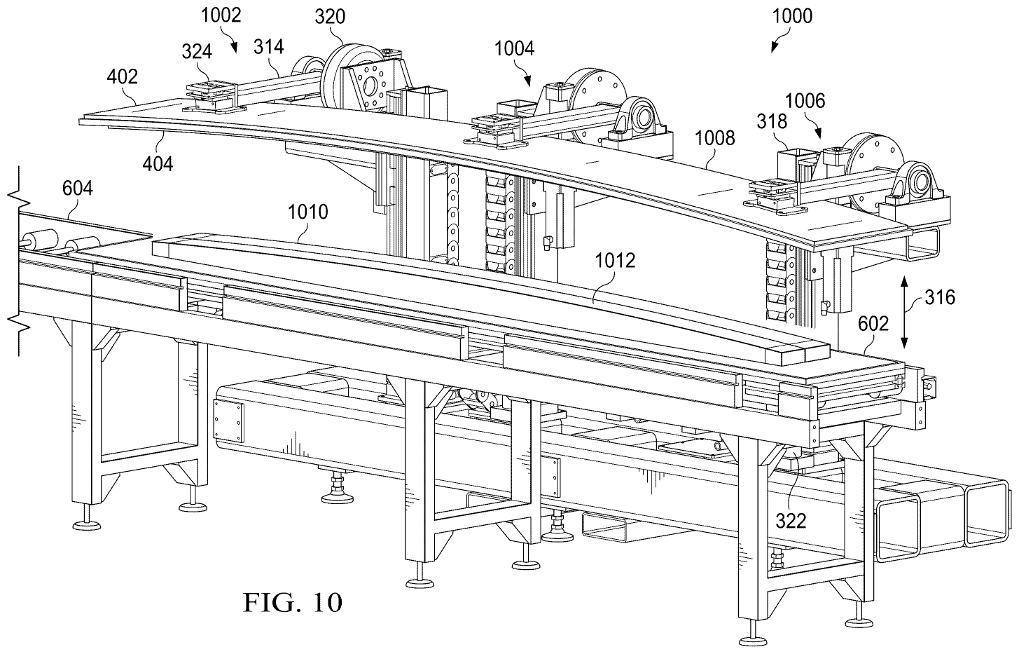

In view 700, view 800, and view 900, tool 308 is planar. As a result, nesting preform transfer portion 502 and composite charge 404 are maintained in a planar configuration. In other illustrative examples, a tool with a curved surface can be present in composite transfer cell 300 instead of tool 308. In these illustrative examples, a curvature is placed into composite charge 404 prior to placing composite charge 404 in contact with the curved tool. FIG. 10 is an example of one implementation of forming a curvature into composite charge 404. View 1000 in FIG. 10 would occur between view 700 and view 800 for tools with a curvature.

Turning now to FIG. 10, an illustration of an isometric view of a composite transfer system placing a curvature into a composite charge on a composite charge transportation pallet in a manufacturing environment in a manufacturing environment is depicted in accordance with an illustrative embodiment. In FIG. 10, composite transfer system 312 places a curvature into composite charge 404 on composite charge transportation pallet 402. Composite transfer cell 300 can be used to place a composite charge in a planar configuration or with a curvature onto a tool.

In this illustrative example, tool 1010 with curved surface 1012 is present on transportation pallet 602 on delivery system 604. Delivery system 604 can be used to transport tools of a variety of different shapes and sizes. Tool 308 of FIGS. 3-9 had a planar surface. Tool 1010 has curved surface 1012. To place composite charge 404 in contact with curved surface 1012, composite transfer system 312 places curvature 1008 into composite charge 404 on composite charge transportation pallet 402 prior to placing composite charge 404 onto tool 1010. In view 700 of FIG. 7, composite charge 404 has been rotated to second side 310 of composite transfer cell 300. Placing curvature 1008 into composite charge 404 in view 1000 occurs after rotating as in view 700 but prior to placing composite charge 404 into contact with tool 1010 with curved surface 1012, similar to in view 800.

In this illustrative example, each of flipper arm 1002, flipper arm 1004, and flipper arm 1006 are moved independently to place curvature 1008 into composite charge 404 on composite charge transportation pallet 402. In this illustrative example, each of flipper arm 1002, flipper arm 1004, and flipper arm 1006 are moved independently by a respective vertical motor of plurality of vertical motors 322 to place curvature 1008 into composite charge 404.

In some illustrative examples, each of flipper arm 1002, flipper arm 1004, and flipper arm 1006 are moved simultaneously but independently in vertical direction 316 to form curvature 1008. In some illustrative examples, flipper arm 1002 and flipper arm 1006 are moved downward in vertical direction 316 while flipper arm 1004 is held in place. Flipper arm 1002, flipper arm 1004, and flipper arm 1006 are moved in a desirable way to form curvature 1008 while maintaining material properties and reducing or preventing inconsistencies in composite charge 404.

Each respective pneumatic and mechanical connector of plurality of pneumatic and mechanical connectors 324 is configured to accommodate movements due to different vertical positions of plurality of flipper arms 314 to impart curvature 1008 in composite charge 404. A slip plane of each respective pneumatic and mechanical connector passively matches the contour, curvature 1008, of nesting preform transfer portion 502 of composite charge transportation pallet 402.

Although curvature 1008 is placed into composite charge 404 on second side 310, in other non-depicted examples, a curvature can be placed into composite charge 404 prior to rotating composite charge 404 from first side 306 to second side 310. When a curvature is placed into composite charge 404 prior to flipping, each of flipper arm 1002, flipper arm 1004, and flipper arm 1006 are moved independently by a respective secondary vertical motor configured to move the respective flipper arm relative to a respective rotary motor. By utilizing a secondary vertical motor configured to move a flipper arm without moving the rotary motor, longitudinal axis 510 can be maintained for rotation of plurality of flipper arms 314.

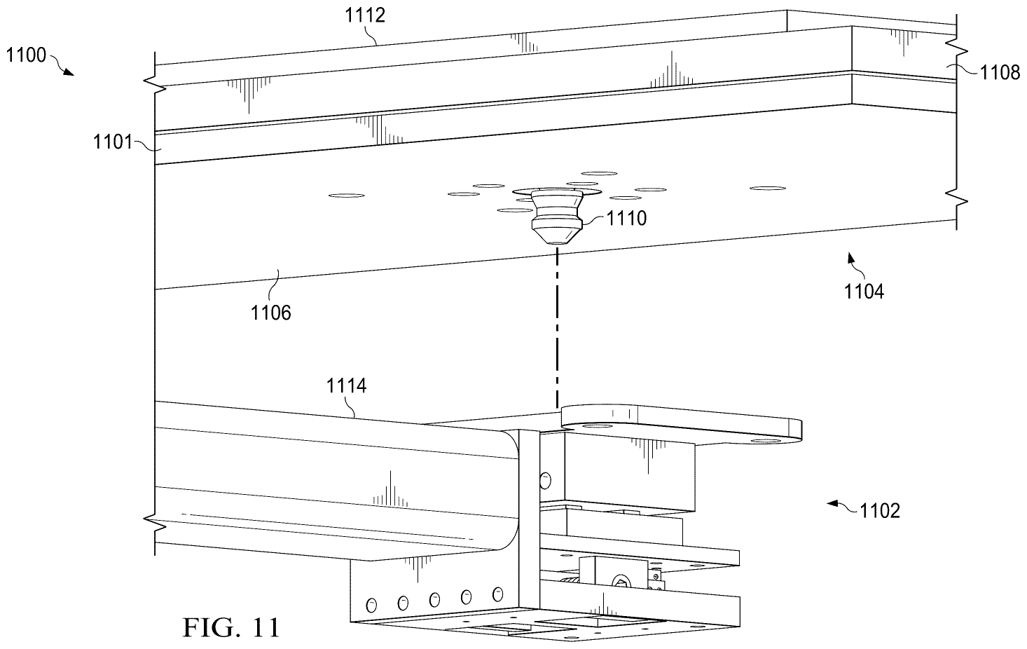

FIGS. 11-15 illustrate embodiments of a pneumatic and mechanical connector for a composite transfer system in accordance with an illustrative embodiment. Turning now to FIG. 11, an illustration of an isometric view of a pneumatic and mechanical connector for a composite transfer system is depicted in accordance with an illustrative embodiment.

In view 1100, pneumatic and mechanical connector 1102 is on flipper arm 1114. Pneumatic and mechanical connector 1102 is positioned beneath nesting preform transfer portion 1104 of composite charge transportation pallet 1101. Nesting preform transfer portion 1104 comprises vacuum plate 1106 and porous vacuum surface 1108. In this illustrative example, composite charge 1112 is in contact with porous vacuum surface 1108. Connector 1110 extends out from vacuum plate 1106. Connector 1110 allows pneumatic and mechanical connector 1102 to engage with nesting preform transfer portion 1104.

Pneumatic and mechanical connector 1102 physically interfaces with connector 1110 to mechanically connect flipper arm 1114 to nesting preform transfer portion 1104 of composite charge transportation pallet 1101. After mechanically connecting pneumatic and mechanical connector 1102 to connector 1110, pneumatics including at least one of air or vacuum can be provided to nesting preform transfer portion 1104 by pneumatic and mechanical connector 1102. The at least one of air or vacuum travels through pneumatic and mechanical connector 1102 to porous vacuum surface 1108. Vacuum provided to porous vacuum surface 1108 holds composite charge 1112 on nesting preform transfer portion 1104 of composite charge transportation pallet 1101. Air sent through porous vacuum surface 1108 can be used to push composite charge 1112 off of nesting preform transfer portion 1104 of composite charge transportation pallet 1101 onto a tool.

Although not depicted in view 1100, prior to connecting pneumatic and mechanical connector 1102 to connector 1110, nesting preform transfer portion 1104 will be present on a layup pallet portion of composite charge transportation pallet 1101. The layup pallet portion (not depicted) is configured to allow pneumatic and mechanical connector 1102 to move through a number of access cut-outs of the layup pallet portion (not depicted) to access connector 1110. In this illustrative example, connector 1110 takes the form of a pin.

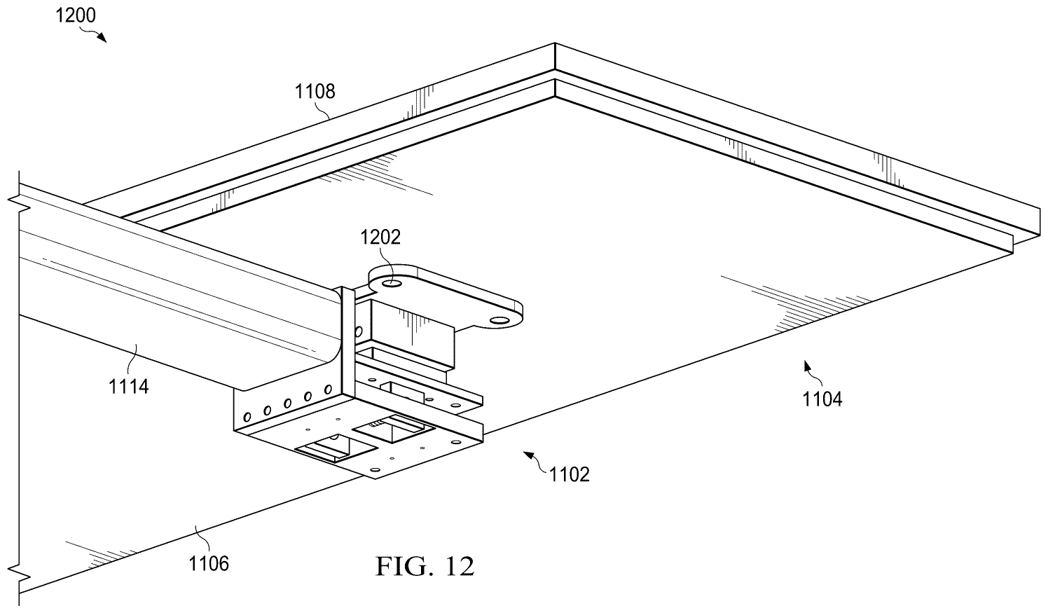

Turning now to FIG. 12, an illustration of a bottom view of a pneumatic and mechanical connector for a composite transfer system is depicted in accordance with an illustrative embodiment. In view 1200, pneumatic and mechanical connector 1102 has connected flipper arm 1114 to nesting preform transfer portion 1104 of composite charge transportation pallet 1101. In view 1200, flipper arm 1114 can now be used to maneuver nesting preform transfer portion 1104 and composite charge 1112 on porous vacuum surface 1108.

Between view 1100 and view 1200, flipper arm 1114 has lifted towards nesting preform transfer portion 1104. Pneumatic and mechanical connector 1102 has engaged with connector 1110. Vacuum can be transferred into nesting preform transfer portion 1104 through the engagement interface. Vacuum ports 1202 are visible in view 1200.

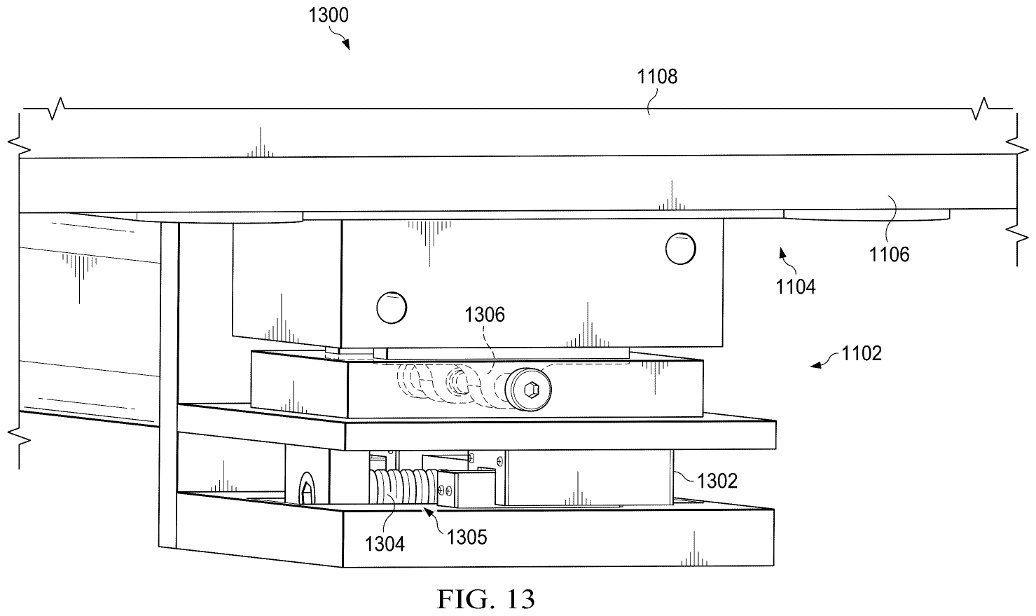

Turning now to FIG. 13, an illustration of a phantom side view of a pneumatic and mechanical connector for a composite transfer system is depicted in accordance with an illustrative embodiment. View 1300 is a side view of pneumatic and mechanical connector 1102 with internal joint components in phantom for ease of description.

Pneumatic and mechanical connector 1102 comprises first joint 1302 configured to allow movement in a first axis, second joint 1306 configured to allow movement in a second axis, and centering component 1305. In this illustrative example, first joint 1302 comprises tracks on a first portion of pneumatic and mechanical connector 1102. In this illustrative example, first joint 1302 comprises a slider joint. In this illustrative example, second joint 1306 comprises a rocker on a third portion of pneumatic and mechanical connector 1102. In some non-depicted illustrative examples, second joint 1306 could comprise a ball joint rather than a rocker joint. A ball joint in the slip plane allows for nesting preform transfer portion 1104 to be in contour and twist prior to the placement of composite charge 1112.

In this illustrative example, centering component 1305 is spring 1304 in a second portion of pneumatic and mechanical connector 1102. A number of springs, spring 1304, provides a passive method to return the joints, first joint 1302 and second joint 1306, to center.

A slip plane formed by the joints of pneumatic and mechanical connector 1102 passively matches a contour formed in nesting preform transfer portion 1104 of composite charge transportation pallet 1101. The slip plane allows nesting preform transfer portion 1104 to be contoured by multiple rigid flipper arms.

Vacuum plate 1106 can be formed of any desirable material. In some illustrative examples, vacuum plate 1106 is a nesting aluminum vacuum plate that has groves cut in to allow for vacuum to be distributed throughout the entirety of porous vacuum surface 1108. In some illustrative examples, porous vacuum surface 1108 comprises a porous polymeric material. In some illustrative examples, the porous polymeric material is a sintered high density polyethylene.

As vacuum plate 1106 is a nesting plate, vacuum plate 1106 can nest into a rigid layup pallet portion during layup. Vacuum plate 1106 is part of a removable section that can be picked and flipped.

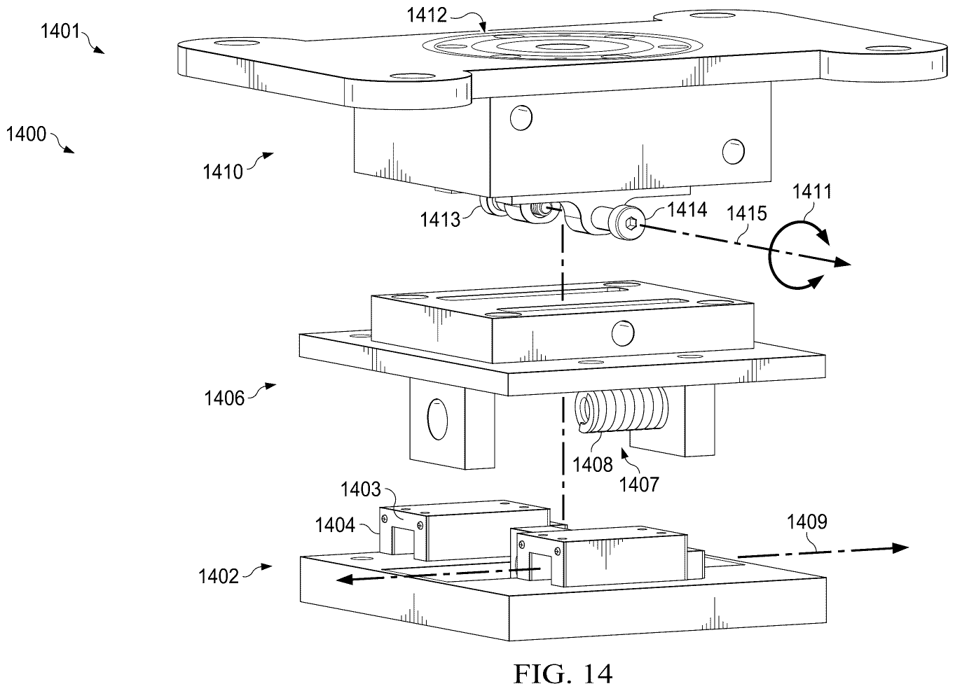

Turning now to FIG. 14, an illustration of an exploded view of a pneumatic and mechanical connector for a composite transfer system is depicted in accordance with an illustrative embodiment. View 1401 is an exploded view of pneumatic and mechanical connector 1400. Pneumatic and mechanical connector 1400 is a physical implementation of one of pneumatic and mechanical connector 220, pneumatic and mechanical connector 232, or pneumatic and mechanical connector 242 of FIGS. 2A and 2B. Pneumatic and mechanical connector 1400 can be one of plurality of pneumatic and mechanical connectors 324 of FIGS. 3-10. Pneumatic and mechanical connector 1400 can be the same design as pneumatic and mechanical connector 1102 of FIGS. 11-13.

Pneumatic and mechanical connector 1400 comprises first joint 1404 configured to allow movement in first axis 1409, second joint 1414 configured to allow movement in second axis 1411, and centering component 1407. In this illustrative example, first joint 1404 comprises tracks on first portion 1402. In this illustrative example, first joint 1404 comprises slider joint 1403. In this illustrative example, second joint 1414 comprises rocker joint 1413 on third portion 1410. In this illustrative example, centering component 1407 is spring 1408 in second portion 1406. Pneumatic and mechanical connector 1400 has quick connector 1412 configured to mechanically connect to a portion of a composite charge transportation pallet.

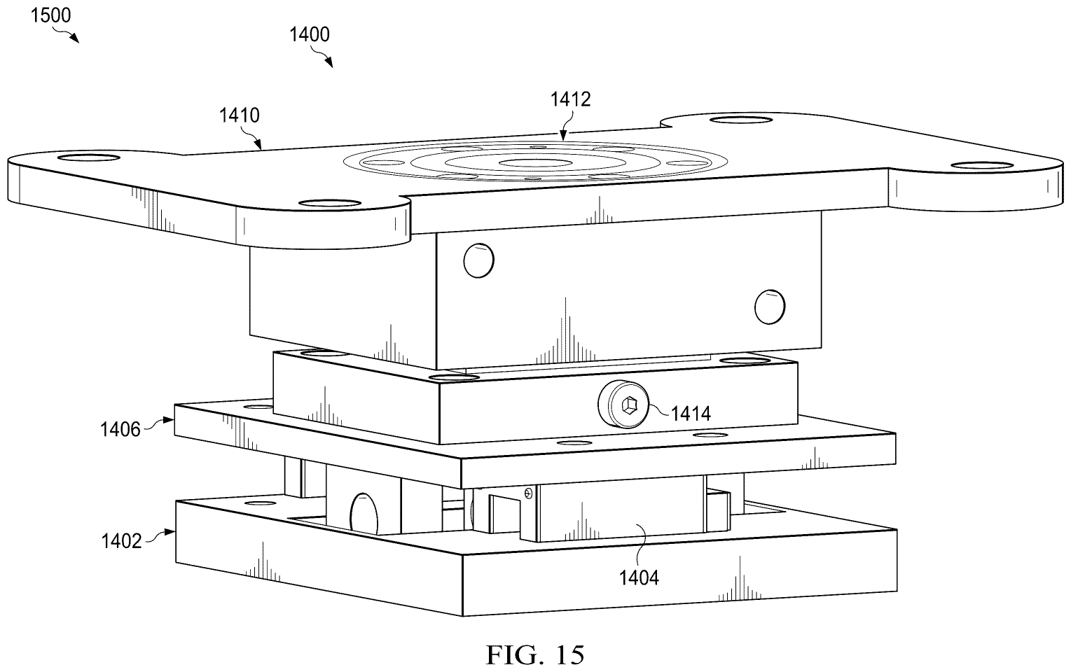

Turning now to FIG. 15, an illustration of an isometric view of a pneumatic and mechanical connector is depicted in accordance with an illustrative embodiment. View 1500 is a view of pneumatic and mechanical connector 1400 in an assembled state. In the assembled state, first portion 1402 and second portion 1406 are joined together by first joint 1404. In the assembled state, second portion 1406 and third portion 1410 are joined together by second joint 1414.

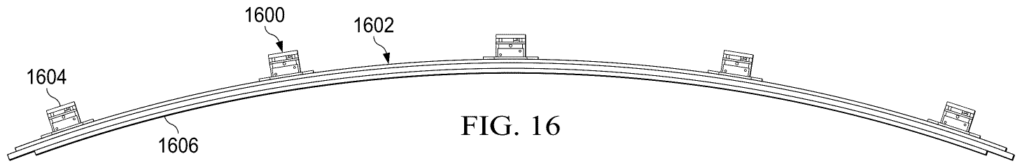

Turning now to FIG. 16, an illustration of a front view of a composite transfer system placing a curvature into a composite charge transportation pallet in a manufacturing environment is depicted in accordance with an illustrative embodiment. Composite transfer system 1600 can be a physical implementation of composite transfer system 203 of FIGS. 2A and 2B. Nesting preform transfer portion 1602 of a composite charge transportation pallet can be a physical implementation of composite charge transportation pallet 252 of FIGS. 2A and 2B. In this illustrative example, plurality of flipper arms 1604 is connected to nesting preform transfer portion 1602. In this illustrative example, plurality of flipper arms 1604 comprises five flipper arms. A quantity of flipper arms in plurality of flipper arms 1604 can be selected based on curvature 1606.

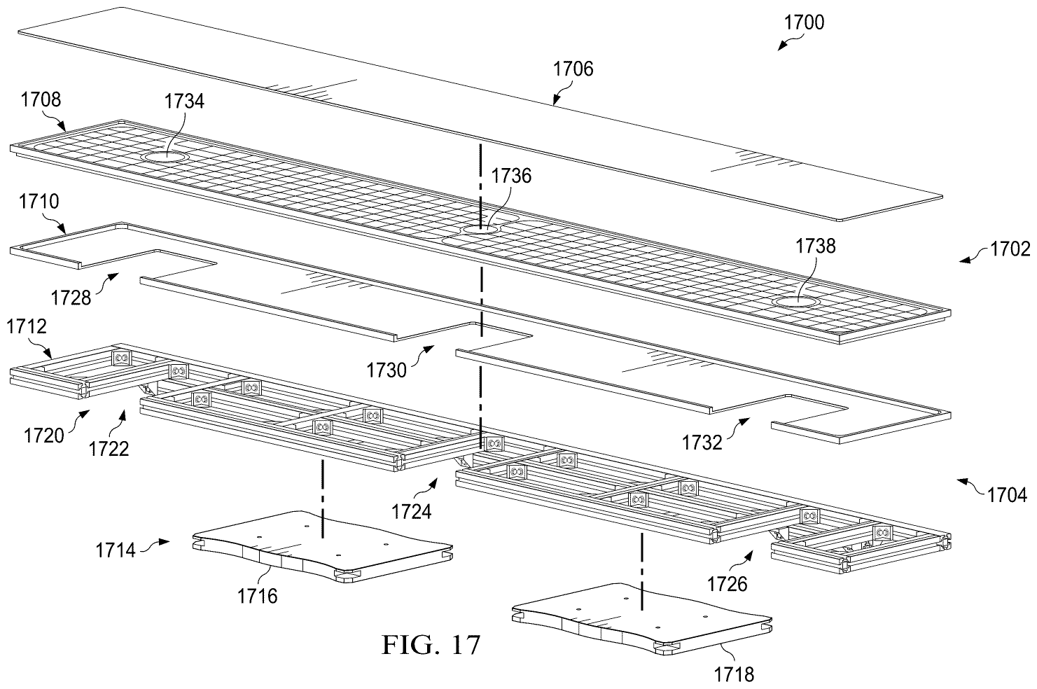

Turning now to FIG. 17, an illustration of an exploded view of a composite charge transportation pallet in a manufacturing environment is depicted in accordance with an illustrative embodiment. Composite charge transportation pallet 1700 is a physical implementation of composite charge transportation pallet 252 of FIGS. 2A and 2B. Composite charge transportation pallet 1700 can be an implementation of composite charge transportation pallet 402 of FIGS. 4-10.

Composite charge transportation pallet 1700 comprises nesting preform transfer portion 1702 and layup pallet portion 1704. Nesting preform transfer portion 1702 comprises vacuum plate 1708 and porous vacuum surface 1706. Porous vacuum surface 1706 interfaces with a composite charge to be placed on a tool. Layup pallet portion 1704 comprises conveyor interface plates 1714, rigid frame 1712, and carrying plate 1710. Conveyor interface plates 1714 create an interface between a delivery system and composite charge transportation pallet 1700. Conveyor interface plates 1714 include conveyor interface plate 1716 and conveyor interface plate 1718. Rigid frame 1712 and carrying plate 1710 have number of access cut-outs 1720 to provide access for pneumatic and mechanical connectors to connect to vacuum plate 1708. Number of access cut-outs 1720 comprise access cut-out 1722, access cut-out 1724, access cut-out 1726, access cut-out 1728, access cut-out 1730, and access cut-out 1732.

Connectors of vacuum plate 1708 comprise connector 1734, connector 1736, and connector 1738. A quantity of connectors can be selected and designed based on at least one of a size of a composite charge to be positioned or a curvature to be placed into the composite charge.

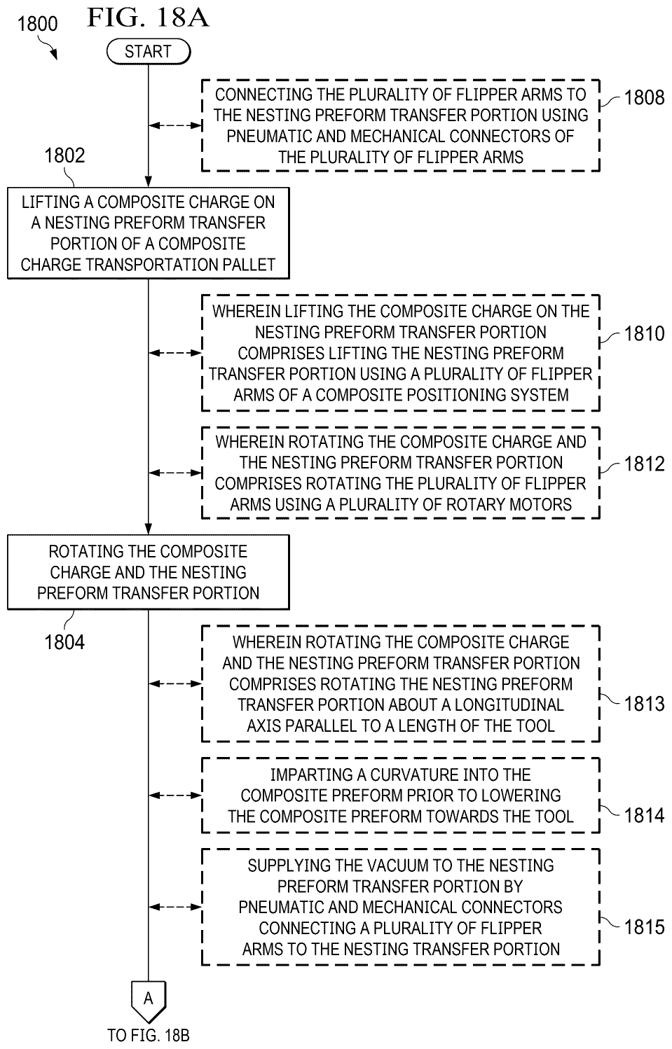

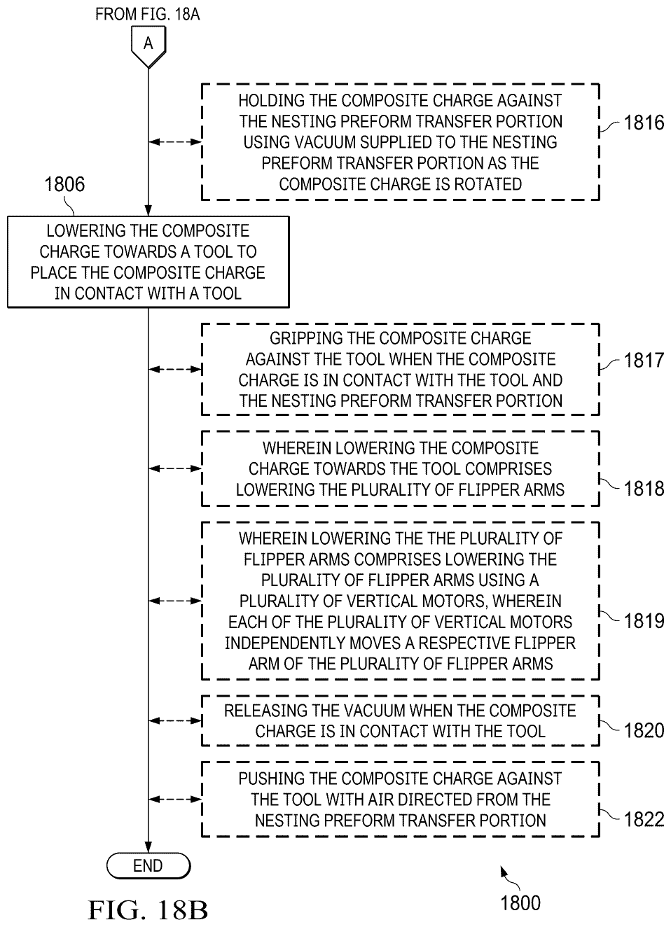

Turning now to FIGS. 18A and 18B, a flowchart of a method of positioning a composite charge is depicted in accordance with an illustrative embodiment. Method 1800 can be performed in manufacturing environment 200 using composite transfer cell 202 of FIGS. 2A and 2B. Method 1800 can be performed in composite transfer cell 300 of FIGS. 3-10. Method 1800 can be performed using a composite transfer system having pneumatic and mechanical connector 1102 of FIGS. 11-13. Method 1800 can be performed using a composite transfer system having pneumatic and mechanical connector 1400 of FIGS. 14 and 15. Method 1800 can be performed using composite transfer system 1600 and nesting preform transfer portion 1602 of a composite charge transportation pallet of FIG. 16. Method 1800 can be performed using composite charge transportation pallet 1700 of FIG. 17.

Method 1800 lifts a composite charge on a nesting preform transfer portion of a composite charge transportation pallet (operation 1802). Method 1800 rotates the composite charge and the nesting preform transfer portion (operation 1804). Method 1800 lowers the composite charge towards a tool to place the composite charge in contact with a tool (operation 1806). Afterwards, method 1800 terminates.

In some illustrative examples, method 1800 connects the plurality of flipper arms to the nesting preform transfer portion using pneumatic and mechanical connectors of the plurality of flipper arms (operation 1808). In some illustrative examples, pneumatic and mechanical connectors of the plurality of flipper arms connect to pins on the nesting preform transfer portion. In some illustrative examples, the pneumatic and mechanical connectors are quick connectors. In some illustrative examples, the pneumatic and mechanical connectors provide at least one of vacuum or air to the nesting preform transfer portion.

In some illustrative examples, lifting the composite charge on the nesting preform transfer portion comprises lifting the nesting preform transfer portion using a plurality of flipper arms of a composite positioning system (operation 1810). In some illustrative examples, rotating the composite charge and the nesting preform transfer portion comprises rotating the plurality of flipper arms using a plurality of rotary motors (operation 1812). In some illustrative examples, rotating the composite charge and the nesting preform transfer portion comprises rotating the nesting preform transfer portion about a longitudinal axis parallel to a length of the tool (operation 1813). In some illustrative examples, lowering the composite charge towards the tool comprises lowering the plurality of flipper arms (operation 1818). In some illustrative examples, lowering the plurality of flipper arms comprises lowering the plurality of flipper arms using a plurality of vertical motors, wherein each of the plurality of vertical motors independently moves a respective flipper arm of the plurality of flipper arms (operation 1819).

In some illustrative examples, method 1800 imparts a curvature into the composite charge prior to lowering the composite charge towards the tool (operation 1814). In some illustrative examples, the curvature is created by independently moving at least one flipper of the plurality of flippers in a vertical direction. In some illustrative examples, multiple flippers of the plurality of flippers are moved vertically to impart a curvature into the composite charge and the nesting preform transfer portion.

In some illustrative examples, method 1800 supplies the vacuum to the nesting preform transfer portion by pneumatic and mechanical connectors connecting a plurality of flipper arms to the nesting transfer portion (operation 1815). In some illustrative examples, method 1800 holds the composite charge against the nesting preform transfer portion using vacuum supplied to the nesting preform transfer portion as the composite charge is rotated (operation 1816).

In some illustrative examples, method 1800 grips the composite charge against the tool when the composite charge is in contact with the tool and the nesting preform transfer portion (operation 1817). The composite charge can be gripped against the tool using any desirable clamp, clip, needles, or any other desirable type of restraint. In some illustrative examples, lowering the composite charge towards the tool comprises lowering the plurality of flipper arms using a plurality of vertical motors, wherein each of the plurality of vertical motors independently moves a respective flipper arm of the plurality of flipper arms (operation 1818).

In some illustrative examples, method 1800 releases the vacuum when the composite charge is in contact with the tool (operation 1820). In some illustrative examples, method 1800 pushes the composite charge against the tool with air directed from the nesting preform transfer portion (operation 1822).

As used herein, the phrase “at least one of,” when used with a list of items, means different combinations of one or more of the listed items may be used and only one of each item in the list may be needed. For example, “at least one of item A, item B, or item C,” may include, without limitation, item A, item A and item B, or item B. This example also may include item A, item B, and item C, or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 1808 through operation 1822 may be optional.

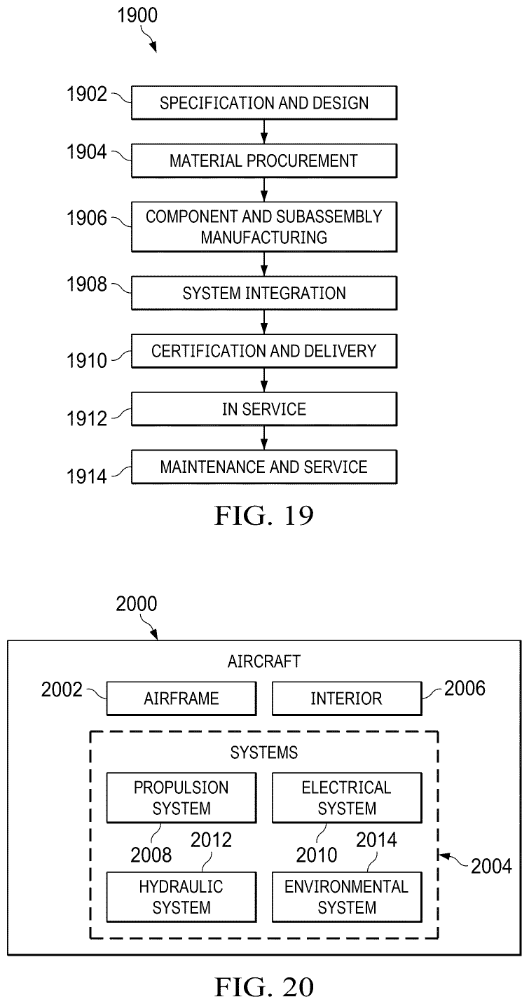

Illustrative embodiments of the present disclosure may be described in the context of aircraft manufacturing and service method 1900 as shown in FIG. 19 and aircraft 2000 as shown in FIG. 20. Turning first to FIG. 19, an illustration of an aircraft manufacturing and service method in a form of a block diagram is depicted in accordance with an illustrative embodiment. During pre-production, aircraft manufacturing and service method 1900 may include specification and design 1902 of aircraft 2000 in FIG. 20 and material procurement 1904.

During production, component and subassembly manufacturing 1906 and system integration 1908 of aircraft 2000 takes place. Thereafter, aircraft 2000 may go through certification and delivery 1910 in order to be placed in service 1912. While in service 1912 by a customer, aircraft 2000 is scheduled for routine maintenance and service 1914, which may include modification, reconfiguration, refurbishment, or other maintenance and service.

Each of the processes of aircraft manufacturing and service method 1900 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 20, an illustration of an aircraft in a form of a block diagram is depicted in which an illustrative embodiment may be implemented. In this example, aircraft 2000 is produced by aircraft manufacturing and service method 1900 of FIG. 19 and may include airframe 2002 with plurality of systems 2004 and interior 2006. Examples of systems 2004 include one or more of propulsion system 2008, electrical system 2010, hydraulic system 2012, and environmental system 2014. Any number of other systems may be included.

Apparatuses and methods embodied herein may be employed during at least one of the stages of aircraft manufacturing and service method 1900. One or more illustrative embodiments may be manufactured or used during at least one of component and subassembly manufacturing 1906, system integration 1908, in service 1912, or maintenance and service 1914 of FIG. 19.

The illustrative examples recognize and take into account several considerations. The illustrative embodiments present a composite transfer system that can pick up a flat composite charge from a delivery system such as a conveyor, flip it, and place it onto a tool. The composite transfer system can put the composite charge in a lengthwise contour. The composite transfer system consists of a two-part vacuum composite charge transportation pallet that interfaces with multiple stanchion arms. The stanchion arms are used to position the composite charge and to control contour. The base portion, also referred to as a layup pallet portion, of the composite charge transportation pallet sits flat on a conveyor. The top portion, or nesting preform transfer portion, of the composite charge transfer pallet is flexible and can engage with the stanchion arms to move into contour. The stanchion arms are designed with appropriate degrees of freedom and slip planes to accommodate contouring and flipping.

In some illustrative examples, a flat composite charge is conveyed into a cell on a two piece pallet. The flipper arms engage with pallet. Vacuum is turned on to the pallet. A flexible piece of the pallet is lifted. The pallet and charge are flipped one hundred and eighty degrees. Flipper arms are optionally individually actuated to contour the pallet and charge. The pallet is lowered by the flipper arms for the composite charge to contact the tool surface.

In some illustrative examples, needle grippers are used to index the composite charge on the tool. The vacuum is turned off to the pallet. In some illustrative examples, air from the pallet blows the composite charge off of the pallet. After placing the composite charge on the tool, the flipper arms return back to a starting position.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A composite transfer cell comprising:
a delivery system on a first side of the composite transfer cell;
a tool on a second side of the composite transfer cell; and
a composite transfer system between the first side and the second side of the composite transfer cell, the composite transfer system comprising a plurality of flipper arms independently movable in a vertical direction and rotatingly movable to lift and place a composite charge from the delivery system to the tool.

2. The composite transfer cell of claim 1, wherein the composite transfer system further comprises:
a plurality of vertical towers; and
wherein the plurality of flipper arms is connected to the plurality of vertical towers by a plurality of vertical motors and a plurality of rotary motors.

3. The composite transfer cell of claim 2, wherein each flipper arm of the plurality of flipper arms comprises a secondary vertical motor configured to move a portion of a respective flipper arm.

4. The composite transfer cell of claim 2, wherein each flipper arm of the plurality of flipper arms comprises a pneumatic and mechanical connector configured to accommodate different vertical positions of the plurality of flipper arms to impart a curvature in the composite charge.

5. The composite transfer cell of claim 4, wherein each pneumatic and mechanical connector comprises:
a first joint configured to allow movement in a first axis;
a second joint configured to allow movement in a second axis; and
a centering component.

6. The composite transfer cell of claim 1 further comprising:
a composite charge transportation pallet having a layup pallet portion and a nesting preform transfer portion removable from the layup pallet portion.

7. The composite transfer cell of claim 6, wherein the layup pallet portion comprises a conveyor interface plate to connect and retain the layup pallet portion on the delivery system.

8. The composite transfer cell of claim 6, wherein the layup pallet portion has a number of access cut-outs configured to allow access to connectors of the nesting preform transfer portion.

9. The composite transfer cell of claim 8, wherein each flipper arm of the plurality of flipper arms comprises a pneumatic and mechanical connector configured to connect to the nesting preform transfer portion.

10. The composite transfer cell of claim 6, wherein the nesting preform transfer portion comprises a vacuum plate and a porous vacuum surface.

11. The composite transfer cell of claim 10, wherein the vacuum plate is formed of a material sufficiently flexible to allow for a curvature to be imparted along a length of the vacuum plate.

12. The composite transfer cell of claim 1, wherein the plurality of flipper arms is rotatingly movable about a longitudinal axis of the composite transfer system, wherein the longitudinal axis of the composite transfer system 203 is parallel to a length of the tool.

13. A composite transfer system comprising:
a plurality of vertical towers; and
a plurality of flipper arms connected to the plurality of vertical towers by a plurality of vertical motors and a plurality of rotary motors.

14. The composite transfer system of claim 13 further comprising:
a respective pneumatic and mechanical connector on each flipper arm of the plurality of flipper arms.

15. The composite transfer system of claim 14, wherein each respective pneumatic and mechanical connector is configured to accommodate movements due to different vertical positions of the plurality of flipper arms to impart a curvature in a composite charge.

16. The composite transfer system of claim 14, wherein each pneumatic and mechanical connector comprises:
a first joint configured to allow movement in a first axis;
a second joint configured to allow movement in a second axis; and
a centering component.

17. The composite transfer system of claim 13 further comprising:
a respective secondary vertical motor connected to each flipper arm of the plurality of flipper arms, wherein each respective secondary vertical motor is configured to move a portion of a respective flipper arm.

18. A pneumatic and mechanical connector comprising:
a first joint configured to allow movement in a first axis;
a second joint configured to allow movement in a second axis; and
a centering component.

19-22. (canceled)

23. A composite charge transportation pallet comprising:
a layup pallet portion; and
a nesting preform transfer portion removable from the layup pallet portion.

24-28. (canceled)

29. A method of positioning a composite charge comprising:
lifting a composite charge on a nesting preform transfer portion of a composite charge transportation pallet;
rotating the composite charge and the nesting preform transfer portion; and
lowering the composite charge towards a tool to place the composite charge in contact with a tool.

30. The method of claim 29, wherein lifting the composite charge on the nesting preform transfer portion comprises lifting the nesting preform transfer portion using a plurality of flipper arms of a composite positioning system.

31. The method of claim 30, wherein rotating the composite charge and the nesting preform transfer portion comprises rotating the plurality of flipper arms using a plurality of rotary motors.

32. The method of claim 30 further comprising:
connecting the plurality of flipper arms to the nesting preform transfer portion using pneumatic and mechanical connectors of the plurality of flipper arms.

33-34. (canceled)

35. The method of claim 29 further comprising:
imparting a curvature into the composite charge prior to lowering the composite charge towards the tool.

36-40. (canceled)

41. The method of claim 29, wherein rotating the composite charge and the nesting preform transfer portion comprises rotating the nesting preform transfer portion about a longitudinal axis parallel to a length of the tool.
